(19) United States
(12) Patent Application Publication
(10) Pub. No.: US 2018/0174072 A1
(43) Pub. Date: Jun. 21, 2018

(54) METHOD AND SYSTEM FOR PREDICTING FUTURE STATES OF A DATACENTER

(71) Applicant: CA, INC., NEW YORK, NY (US)

(72) Inventors: DAVID SANCHEZ CHARLES, BARCELONA (ES); JAUME FERRARONS LLAGOSTERA, BARCELONA (ES); ALBERTO HUELAMO SEGURA, BARCELONA (ES); VICTOR MUNTES MULERO, BARCELONA (ES); DAVID SOLANS NOGUERO, BARCELONA (ES); MARC SOLE SIMO, BARCELONA (ES)

(21) Appl. No.: 15/392,565

(22) Filed: Dec. 28, 2016

(30) Foreign Application Priority Data
Dec. 21, 2016 (ES) P 201631645

(51) Int. Cl. G06N 99/00; G06N 5/02

(52) U.S. Cl. CPC G06N 99/005; G06N 5/022

(57) ABSTRACT

In a datacenter setting, future states of nodes of a datacenter (each node representing a component of the datacenter in a context graph) are predicted. Initially, historical metrics collected from the datacenter nodes, as well as historical metrics of neighboring nodes. The metrics are aggregated into historical metric summary vector representations of the nodes which are utilized to train a future state predictor to predict future datacenter states. Once trained, metrics may be input into the future state predictor and the future state predictor may be utilized to predict a future state of one or more of the nodes of the datacenter.

### RELATED APPLICATION

This application claims priority to Spanish Application No. P 201631645, filed Dec. 21, 2016.

### BACKGROUND

Datacenters are large clusters of components (e.g., hardware and/or software resources) that are connected to perform operations using massive amounts of data. Keeping these components working efficiently is a complex task as many incidents may occur during the execution of the processes. In order to detect anomalies, problems, and/or failures, or to otherwise assess the health of the system, tools are utilized that extract and gather metrics from the datacenter components. Metrics may include, by way of example only, the temperature of datacenter components, workload, network usage, processor capacity, and the like. The set of metrics at a given timestamp forms the state of the datacenter at the point in time represented by the timestamp. While much may be gleaned from a datacenter state, the information is indicative of conditions that have already taken place and, accordingly, does little to facilitate mitigation of problems or failures before they occur.

### SUMMARY

This summary is provided to introduce a selection of concepts in a simplified form that are further described below in the detailed description. This summary is not intended to identify key features or essential features of the claimed subject matter, nor should it be used as an aid in determining the scope of the claimed subject matter.

Embodiments of the present disclosure relate to predicting future states of nodes of a datacenter (each node representing a component of the datacenter in a context graph) utilizing a trained future state predictor. The evolution of recent states of the datacenter is analyzed by examining historical metrics collected from the datacenter nodes, as well as historical metrics of neighboring nodes. The metrics are aggregated into historical metric summary vector representations of the nodes which are utilized to train a future state predictor to predict future datacenter states. Once trained, metrics may be input into the future state predictor and the future state predictor may be utilized to predict a future state of one or more of the nodes of the datacenter.

### BRIEF DESCRIPTION OF THE DRAWINGS

The present invention is described in detail below with reference to the attached drawing figures, wherein:

FIG. 1 is a block diagram showing a system configured to predict future states of nodes in a datacenter, in accordance with an embodiment of the present disclosure;

FIG. 2 is a schematic diagram illustrating collection of metrics from datacenter nodes, in accordance with an embodiment of the present disclosure;

FIG. 3 is an exemplary hash algorithm for context graph nodes using a single property, in accordance with an embodiment of the present disclosure;

FIG. 4 is an exemplary hash algorithm for context graph nodes using multiple properties, in accordance with embodiments of the present disclosure;

FIG. 5 is a schematic diagram illustrating state discovery and generation of vector representations, in accordance with embodiments of the present disclosure;

FIG. 6 is a schematic diagram illustrating training of a model for predicting future states of a datacenter, in accordance with embodiments of the present disclosure;

FIG. 7 is a schematic diagram illustrating use of a system for predicting future states in a datacenter utilizing a decision support component, in accordance with embodiments of the present disclosure;

FIG. 8 is a schematic diagram illustrating use of a system for predicting future states in a datacenter utilizing a future state predictor component, in accordance with embodiments of the present invention;

FIG. 9 is a schematic diagram illustrating use of a system for predicting future states in a data center utilizing comparison, in accordance with embodiments of the present invention;

FIG. 10 is a flow diagram illustrating a method that facilitates training a future state predictor to predict a future state of a node of an input datacenter, in accordance with embodiments of the present disclosure;

FIG. 11 is a flow diagram illustrating a method that facilitates predicting a future state of a node in a datacenter, in accordance with embodiments of the present disclosure; and

FIG. 12 is a block diagram of an exemplary computing environment suitable for use in implementing embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. For example, although this disclosure refers to generating context graphs that represent datacenters in illustrative examples, aspects of this disclosure can be applied to generating context graphs that represent relationships between components in a local hardware or software system, such as a storage system or distributed software application. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

The term “component” as used in the description below encompasses both hardware and software resources. The term component may refer to a physical device such as a computer, server, router, etc., a virtualized device such as a virtual machine or virtualized network function, or software such as an application, a process of an application, a database management system, etc. A component may include other components. For example, a server component may include a web service component which may include a web application component.

The term “context graph” refers to a data structure that depicts connections or relationships between components. A context graph consists of nodes (vertices, points) and edges (arcs, lines) that connect them. A node represents a component, and an edge represents a relationship between the corresponding components. Nodes and edges may be labeled or enriched with data or properties. For example, a node may include an identifier for a component, and an edge may be labeled to represent different types of relationships, such as a hierarchical relationship or a cause-and-effect type relationship. In embodiments where nodes and edges are enriched with data, nodes and edges may be indicated with data structures that allow for the additional information, such as JavaScript Object Notation (“JSON”) objects, extensible markup language (“XML”) files, etc. Context graphs also may be referred to in related literature as a triage map, relationship diagram/chart, causality graph, etc.

The term “subgraph” refers to a portion of a context graph. Subgraphs may be stored in a historical database as training data and may be aggregated to facilitate data imputation for missing data in a context graph. Subgraphs may additionally be utilized to diagnose particular problems in a datacenter. For example, if a particular problem occurs, the subgraphs utilized to generate a particular hash for the particular problem may be provided to help identify a source of the problem in the datacenter.

Properties of a subgraph or context graph may be described by “hash.” A hash may be determined based on a particular property or properties of a node. The properties may be metrics of the node itself or information related to one or more neighbors of the node. If related to multiple node neighbors, the information may be aggregated. The aggregated neighbor-related information may include, by way of example only, a number of neighbors of the node, an absolute number of neighbors having a particular condition, a relative number of neighbors having a particular condition, a sum/maximum/minimum/average of one or more node properties, and the like. For clarity, a “neighbor” is a node that is directly connected to the subject node by an edge. The edge may correspond to relationships among hardware and software components between the nodes.

A hash may additionally be computed through a predetermined number of iterations which may be based on a diameter of the subgraph or context graph, desired input size, etc. For example, at iteration 0, the hash may include a hash of the particular node. At iteration 1, the hash may include a hash of the hash of the particular node and the hash of neighbor nodes. At iteration 2, the hash may include a hash of the hash of the particular node, the hash of the neighbor nodes, and the hash of the neighbors of the neighbor nodes. In this way the hash provides a fingerprint or identifying characteristics of the context graph or subgraph corresponding to properties of nodes of the context graph or subgraph that can be utilized to identify similar context graphs or subgraphs. Subgraphs and/or context graphs may be “similar” to one another when a threshold level of similarity (as measured by similar nodes, similar node properties, similar connections between nodes, and the like) exists between items being measured. The threshold necessary for a similarity determination may be configured to use cases, as desired, and embodiments of the present disclosure are not intended to be limited to any particular threshold similarity.

A “vector representation” or “graph embedding” may correspond to the hash itself or a string of hashes being considered (e.g., hashes of multiple properties or for multiple nodes). In embodiments, a vector representation corresponds to a context graph or subgraph as it evolves over time. For example, as a particular property or node changes over time, a vector representation may represent the hash of the particular node as it changes over time which may help diagnose a particular a root cause of an anomalous condition, predict a future state of a datacenter (e.g., a particular property or particular node), identify missing properties, summarize a state of the datacenter, compare states of the datacenter, and the like.

As previously set forth in the Background, datacenters are large clusters of components (e.g., hardware and/or software resources) that are connected to perform operations using massive amounts of data. Keeping these components working efficiently is a complex task as many incidents may occur during the execution of the processes. In order to detect anomalies, problems, and/or failures, or to otherwise assess the health of the system, tools are utilized that extract and gather metrics from the datacenter components. Metrics may include, by way of example only, the temperature of datacenter components, workload, network usage, processor capacity, and the like. The set of metrics at a given timestamp forms the state of the datacenter at the point in time represented by the timestamp. While much may be gleaned from a datacenter state, the information is indicative of conditions that have already taken place and, accordingly, does little to facilitate mitigation of problems or failures before they occur.

Embodiments of the present disclosure are generally directed to predicting future states of nodes of a datacenter (each node representing a component of the datacenter in a context graph) utilizing a trained future state predictor. The evolution of recent states of the datacenter is analyzed by examining historical metrics collected from the datacenter nodes, as well as historical metrics of neighboring nodes. The metrics are aggregated into historical metric summary vector representations of the nodes which are utilized to train a future state predictor to predict future datacenter states. Once trained, metrics may be input into the future state predictor and the future state predictor may be utilized to predict a future state of one or more of the nodes of the datacenter.

In practice, historical metrics are collected from a plurality of historical nodes of a historical datacenter, that is, a datacenter for which the historical metrics have been collected on the historical nodes for a threshold period of time. Such threshold period of time may be configurable as desired and any particular threshold time period is not intended to limit the scope of embodiments of the present disclosure. Collected metrics may include, by way of example only and not limitation, the temperature of the components represented by the historical nodes, workload of the historical nodes, network usage of the historical nodes, input/output (I/O) operations of the historical nodes, functionality of the historical nodes, processor capacity, and the like. In embodiments, this historical data is assimilated and utilized to train a future state predictor to predict future states of datacenters, as more fully described below. Each of the historical nodes corresponds to a historical context graph or subgraph that represents the components of the historical datacenter and the relationships that exist between those components.

In addition to the local metrics of the historical nodes discussed above, information and metrics related to each node's neighborhood are also collected. By way of example and not limitation, such neighborhood information and metrics may include connections between historical nodes, traffic between historical nodes, the number or percentage of neighboring nodes of a historical node having a particular condition, and the like. In embodiments, the historical information and metrics collected do not include any global property related to the historical datacenter. For instance, in such embodiments, the historical information and metrics collected would not include the geolocation, humidity, temperature outside the historical nodes, and the like for the historical datacenter. In this way, the collected historical metrics and information may include historical metrics from a plurality of datacenters and the trained future state predictor may be utilized to predict future states of a datacenter that was not considered during the training phase.

Historical metrics and information collected are aggregated into historical metric summary vector representations for the plurality of historical nodes in the historical datacenter, the historical metric summary vector representations summarizing the collected historical metrics and the topology of the datacenter. The historical metric summary vector representations may include information derived from the historical metrics of neighboring nodes of the plurality of historical nodes as well as metrics and information regarding the historical nodes themselves.

In embodiments, concatenated to the historical metric summary vector is a vector indicating whether particular node state patterns are satisfied by the corresponding node. A node state pattern is a subgraph with particular conditions on the state of the nodes. In embodiments, in addition to using the aggregated metric information, a list of node state patterns may be consulted and a node state pattern vector indicating whether such node state patterns are satisfied may be appended providing a more global overview of the state of the datacenter.

After aggregation of the historical metric information (and node state pattern data, if desired) into enhanced historical vector representations for the plurality of historical nodes in the historical datacenter, such enhanced historical vector representations are utilized to train a future state predictor that approximates the known evolution of the datacenter based on the information contained in a time-window prior to a given state. The trained future state predictor may then be utilized to predict future states of nodes of an input datacenter. It will be understood and appreciated by those having ordinary skill in the art that historical metric summary vector representations may be utilized to train the future state predictor without having the node state pattern vector concatenated thereto. It will be further understood that vectors other than node state pattern vectors may be concatenated to the metric summary vectors, as desired. Any and all such variations, and any combination thereof, are contemplated to be within the scope of embodiments of the present disclosure.

Accordingly, one embodiment of the present disclosure is directed to a method that facilitates training a future state predictor to predict a future state of a node of an input datacenter. The method includes receiving historical metrics from a plurality of historical nodes of a historical datacenter, the plurality of historical nodes corresponding to a historical context graph indicating a plurality of relationships among the plurality of historical nodes. Each historical node corresponds to a component of the historical datacenter. The method further includes aggregating the historical metrics into historical metric summary vector representations for the plurality of historical nodes in the historical datacenter. The historical metric summary vector representations include information derived from the historical metrics of neighbors of the plurality of historical nodes. Still further, the method includes training a future state predictor with the historical metric summary vector representations to predict a future state of a node of an input datacenter.

In another embodiment, the present disclosure is directed to a method that facilitates predicting a future state of a node in a datacenter. The method includes receiving metrics from a plurality of nodes in a datacenter, the plurality of nodes corresponding to a context graph indicating a plurality of relationships among the plurality of nodes. Each node corresponds to a component of the datacenter. The method further includes aggregating the metrics into a metric summary vector representation for a node of the plurality of nodes in the datacenter. The metric summary vector representation corresponds to a time-window prior to a future state and includes information derived from the metrics of neighbors of the node. Still further, the method includes utilizing a future state predictor that has been trained to predict future states of the node, predicting a future state of the node.

In yet another embodiment, the present disclosure is directed to a computerized system that utilizes a future state predictor to predict a future state of a node in a datacenter. The system includes a processor and a non-transitory computer storage medium storing computer-useable instructions that, when used by the processor, cause the processor to receive historical metrics from a plurality of historical nodes in a historical datacenter corresponding to a historical context graph indicating a plurality of relationships among the plurality of historical nodes corresponding to components of the historical datacenter. When used by the processor, the computer-useable instructions further cause the processor to aggregate the historical metrics into historical metric summary vector representations for the plurality of historical nodes in the historical datacenter. The historical metric summary vector representations include information derived from the historical metrics of neighbors of the plurality of historical nodes. Still further, when used by the processor, the computer-useable instructions cause the processor to train a future state predictor with the historical metric summary vector representations to predict a future state of an input datacenter, receive metrics from a plurality of nodes in the datacenter corresponding to a time-window prior to the future state, and aggregate the metrics into a metric summary vector representation for the node of the plurality of nodes in the datacenter. The metric summary vector representation corresponds to the time-window prior to the future state and includes information derived from the metrics of neighbors of the node. When used by the processor, the computer-useable instructions additionally cause the processor, utilizing the future state predictor, to predict the future state of the node.

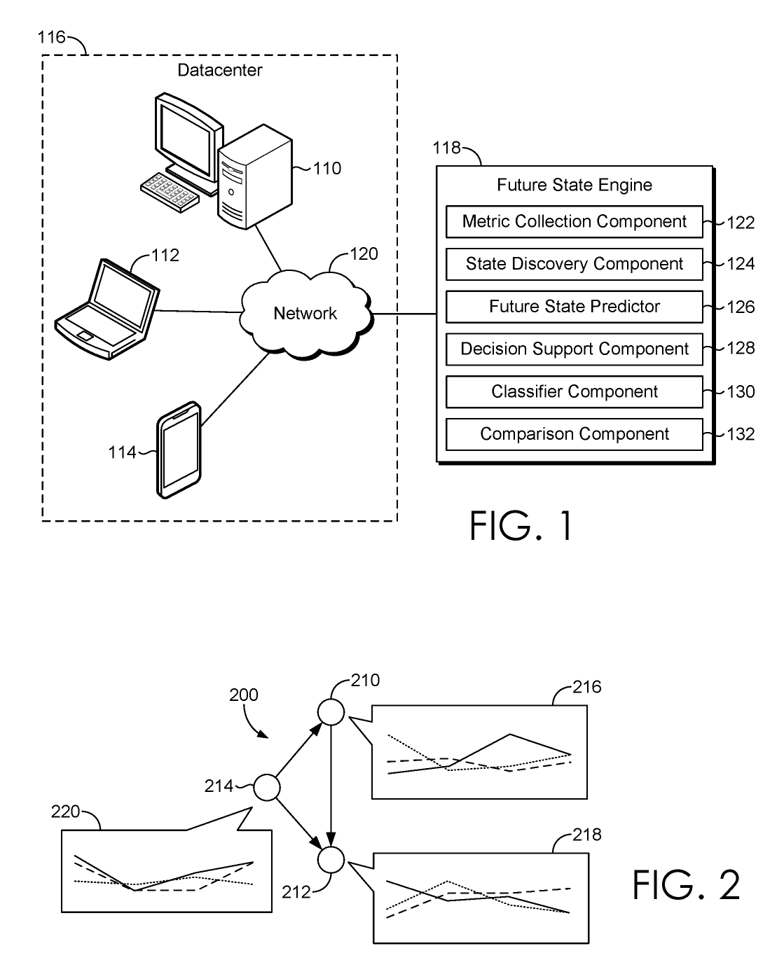

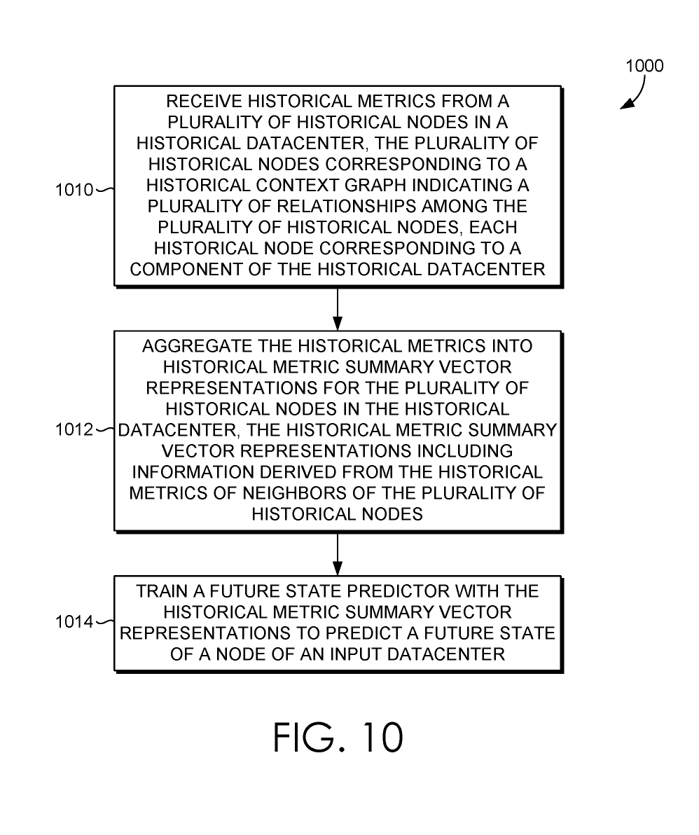

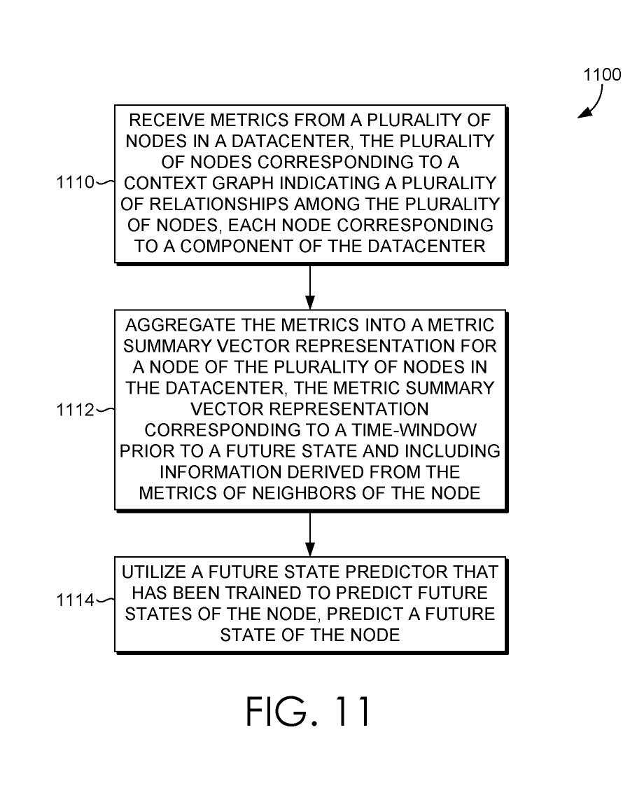

Referring now to FIG. 1, a block diagram is provided that illustrates a system 100 for predicting future states of nodes in a datacenter, in accordance with an exemplary embodiment of the present disclosure. Generally, the system 100 illustrates an environment in which future states of nodes in a datacenter may be predicted in accordance with the methods, for instance, illustrated in FIGS. 10 and 11 (more fully described below). Among other components not shown, the future state prediction system 100 includes plurality of datacenter resources 110, 112, 114 comprising a datacenter 116 and a future state engine 118, all in communication with one another through a network 120. The network 120 may include, without limitation, one or more local area networks (LANs) and/or wide area networks (WANs). Such networking environments are commonplace in offices, enterprise-wide computer networks, intranets, and the Internet and, accordingly, the network 120 is not further described herein. It should be understood that any number of datacenters 116, datacenter resources 110, 112, 114 and/or future state engines 118 may be employed by the future state prediction system 100 within the scope of the present disclosure. Each may comprise a single device or multiple devices cooperating in a distributed environment. Additionally, other components not shown may also be included within the network environment.

In some embodiments, one or more of the illustrated components/modules may be implemented as stand-alone applications. In other embodiments, one or more of the illustrated components/modules may be implemented via a server or as an Internet-based service. It will be understood by those having ordinary skill in the art that the components/modules illustrated in FIG. 1 are exemplary in nature and in number and should not be construed as limiting. Any number of components/modules may be employed to achieve the desired functionality within the scope of embodiments hereof.

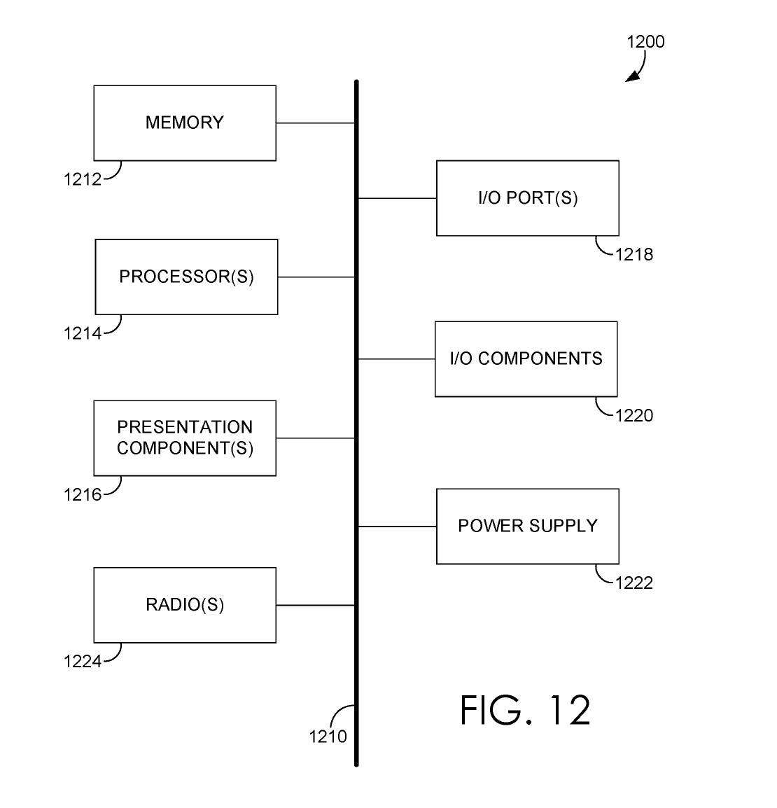

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The future state prediction system 100 may be implemented via any type of computing device, such as computing device 1200 described below with reference to FIG. 12, for example. In various embodiments, the future state prediction system 100 may be implemented via a single device or multiple devices cooperating in a distributed environment.

The future state prediction system 100 generally operates to predict future states of nodes in a datacenter. It should be understood that the future state prediction system 100 shown in FIG. 1 is an example of one suitable computing system architecture. Each of the components shown in FIG. 1 may be implemented via any type of computing device, such as computing device 1200 described with reference to FIG. 12, for example.

The future state prediction system 100 of FIG. 1 includes a metric collection component 122, a state discovery component 124, a future state predictor 126, a decision support component 128, a classifier component 130, and a comparison component 132. The metric collection component 122 is configured to receive historical metrics from a plurality of historical nodes of a historical datacenter. In embodiments, the plurality of historical nodes corresponds to one or more historical context graphs indicating a plurality of relationships among the plurality of historical nodes. Each historical node corresponds to a component of the historical datacenter.

Metric collection is illustrated in the schematic diagram of FIG. 2. Illustrated is an exemplary context graph 200 having three nodes 210, 212, 214. Each node 210, 212, 214 includes metrics associated therewith (illustrated as 216, 218, 220, respectively).

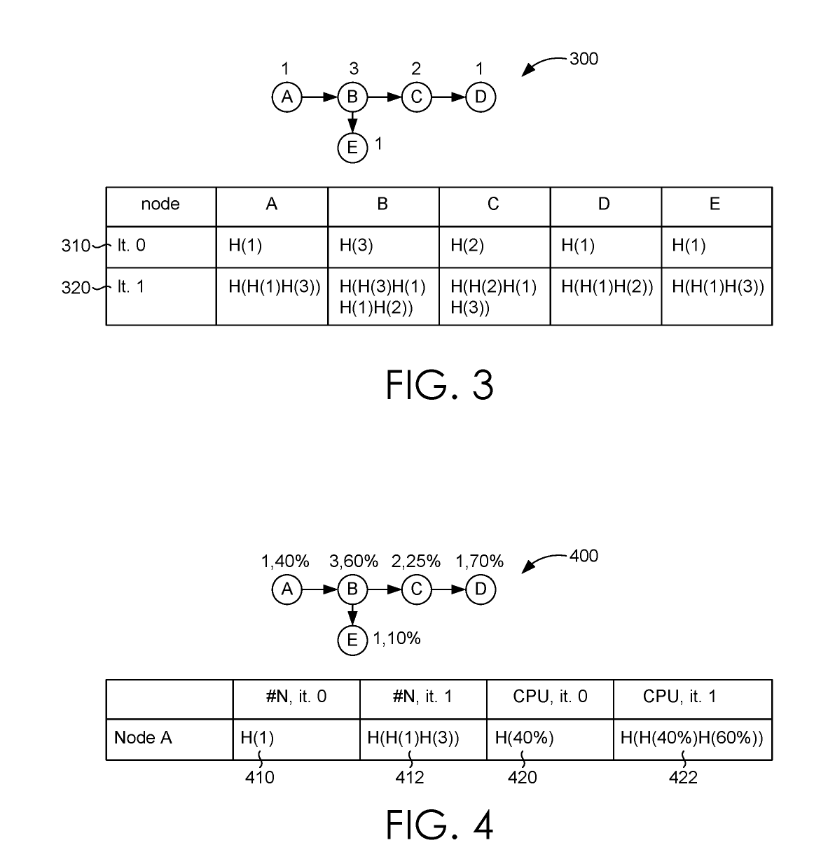

With reference back to FIG. 1, the state discovery component 124 is configured to aggregate the historical metrics into historical metric summary vector representations for the plurality of historical nodes in the historical datacenter. In embodiments, the historical metric summary vector representations include information derived from the historical metrics of the context graph nodes and information derived from historical metrics of neighbors of the context graph nodes. With reference to FIG. 3, an exemplary hash algorithm is illustrated for determining a hash from which historical metric summary vector representations may be generated for context graph nodes using a single property, in accordance with an embodiment of the present disclosure. The hash may be determined by the state discovery component 124 of the future state prediction system 100 of FIG. 1 utilizing the hash algorithm as shown. In this example, a hash may be determined for each node of the context graph or subgraph 300 based on selected properties. The properties may include metrics of the node and/or neighbor-related information (which may be aggregated for multiple neighbor nodes). The neighbor-related information may include a number of neighbors, an absolute number of neighbors having a particular condition, a relative number of neighbors having a particular condition, a sum/maximum/minimum/average of one or more node properties, and the like. A number of iterations 310, 320 may also be utilized to determine the hashes. The number of iterations may be based on a diameter of the context graph or subgraph, a desired input size, etc. The information associated to a single node are the values in its column in the table for each iteration 310, 320.

For example, using a number of neighbors as the selected property, at iteration 0, the hash of node A is represented by H(1) because its only neighbor is node B. Under the same properties, the hash of nodes B, C, D, E are represented by H(3), H(2), H(1), and H(1) because nodes B, C, D, E have 3, 2, 1, 1 neighbors, respectively. In some embodiments, the direction of the edges is ignored. In other embodiments, the direction of the edges is utilized as a property.

In the same example, and still referring to FIG. 3, at iteration 1, the hash of node A considers a hash of (the hash of node A and the hash of node B) which can be represented by H(H(1)H(3)). Under the same properties, the hash of nodes B, C, D, E are represented by H(H(3)H(1)H(1)H(2)), H(H(2)H(1)H(3)), H(H(1)H(2)), and H(H(1)H(2)). As can be appreciated, this circular hashing process can be utilized for multiple iterations or depths of the context graph to provide a fingerprint or identifying characteristics of the context graph corresponding to the selected properties of nodes of the context graph which can be utilized to identify similar context graphs or subgraphs.

Turning now to FIG. 4, an exemplary hash algorithm for context graph nodes is illustrated using multiple properties, in accordance with an embodiment of the present disclosure. The hash may be determined by the state discovery component 124 of the future state engine 118 of FIG. 1 utilizing the hash algorithm as shown. For example, using a number of neighbors as the selected property, at iteration 0, the hash of node A is represented by H(1) 410 because its only neighbor is node B. At iteration 1, the hash of node A considers a hash of (the hash of node A and the hash of node B) which can be represented by H(H(1)H(3)) 412. Similarly, using CPU as the selected property, at iteration 0, the hash of node A is represented by H(40%) 420. At iteration 1, the hash of node A considers a hash of (the hash of node A and the hash of node B) which can be represented by H(H(40)H(60)) 422.

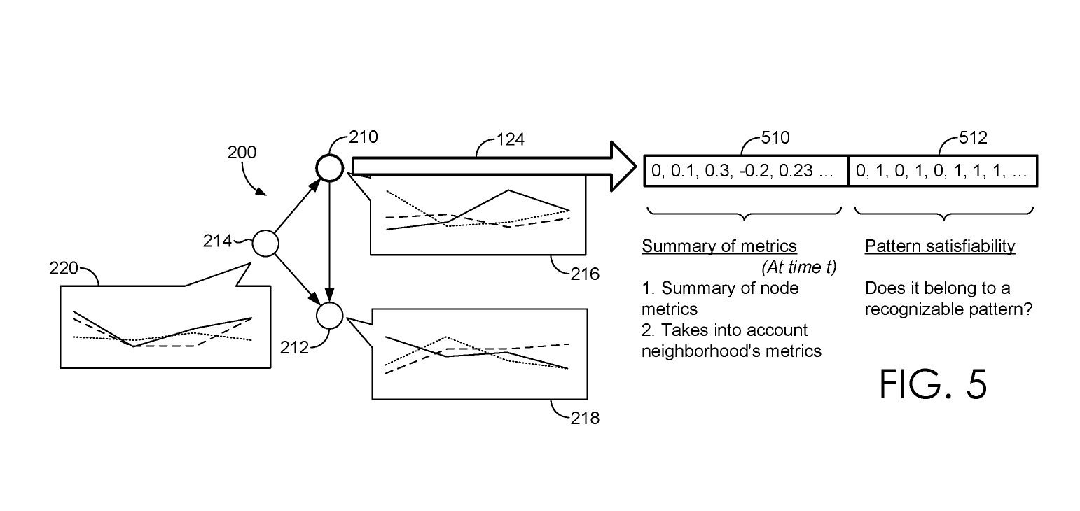

With reference back to FIG. 1, the state discovery component 124 is configured to utilize the determined hashes to generate historical metric summary vector representations for the context graph corresponding to the received metrics, in accordance with embodiments of the present disclosure. Vector representation generation is illustrated with reference to the schematic diagram of FIG. 5. The context graph 200 having nodes 210, 212, 214 and corresponding metrics 216, 218, 220 is utilized by the state discovery component 124 to generate a historical metric summary vector representation 510 for each of the nodes 210, 212, 214. Each historical metric summary vector representation 510 includes a summary of metrics for the subject node (one of nodes 210, 212, 214) at time t. Each historical metric summary vector representation 510 additionally includes a summary of the neighbor-related metrics.

In embodiments, and as illustrated in FIG. 5, concatenated to the historical metric summary vector 510 is a vector 512 indicating whether particular node state patterns are satisfied by the corresponding node. A node state pattern is a subgraph with particular conditions on the state of the nodes. In embodiments, in addition to using the aggregated metric information, a list of node state patterns may be consulted and a vector indicating whether such node state patterns are satisfied may be appended providing a more global overview of the state of the datacenter. Generally, satisfaction of a node state pattern results in a “1” and dissatisfaction of a node state pattern results in a “0” in the node state pattern vector 512. In embodiments, the node state pattern vector 512 could be extended to include partial pattern satisfaction such that values between 0 and 1 may be possible. Any and all such variations, and any combination thereof, are contemplated to be within the scope of embodiments of the present disclosure.

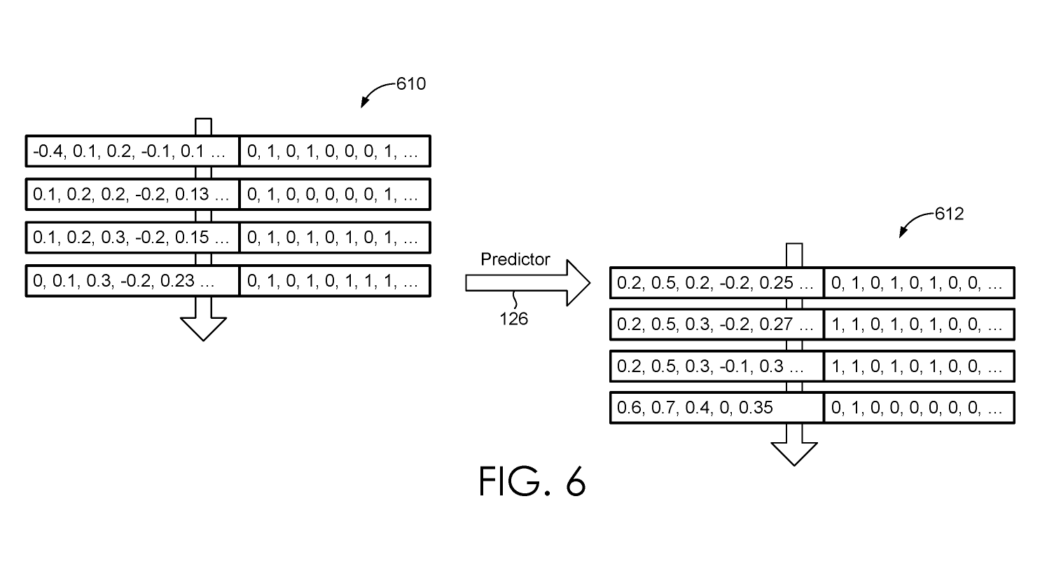

With reference back to FIG. 1, utilizing the enhanced historical vector representations, the future state predictor 126 is trained with the enhanced historical vector representations to predict a future state of a node of an input datacenter. The state discovery component 124 of FIG. 1 outputs a plurality of enhanced historical vector representations. These enhanced historical vector representations may be considered for a given window of timestamps (where each enhanced historical vector representation is generated for a given node at one timestamp). Training of the future state predictor is illustrated in the schematic diagram of FIG. 6. A plurality of enhanced historical vector representations 610 corresponding to a plurality of timestamps is illustrated. The enhanced historical vector representations 610 are utilized to train a recurrent neural network. For each enhanced historical vector representation, K prior states are considered and, based upon this historical information, the recurrent neural network is trained such that it predicts the next N states corresponding to the next N timestamps. Output is a plurality of enhanced vector representations 612 representing the next N states for the node to which the input enhanced historical vector representations 610 correspond.

Once trained, the future state predictor 126 may be utilized to predict future states for input metrics. As previously described with respect to training the future state predictor 126, metrics are collected. This time, however, metrics are collected from a plurality of nodes in a datacenter for which future state prediction is desired (as opposed to historical metrics). The metrics may be received, for instance, utilizing the metric collection component 122 of FIG. 1. The metrics may be aggregated into a metric summary vector representation for one or more of the corresponding nodes, the metric summary vector representation corresponding to a time-window prior to a future state and including information derived from the metrics of neighbors of the one or more nodes corresponding to the collected metrics. The metrics may be aggregated, for instance, utilizing the state discovery component 124 of FIG. 1. The future state predictor 126 may then be utilized to predict one or more future states of the node.

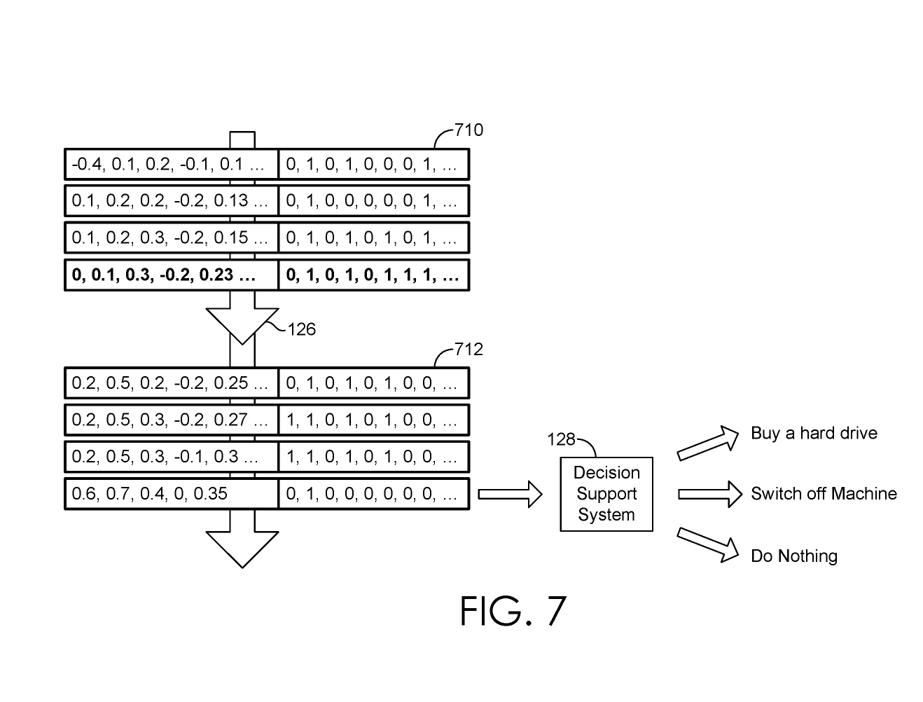

Use of the trained future state predictor 126 is depicted in the schematic diagrams of FIGS. 7, 8 and 9. In each figure, enhanced vectors 710 representing the node for which future state prediction is desired at a plurality of timestamps are input and enhanced vectors 712 representing a plurality of predicted future states is output by the future state predictor 126. Once output, the predicted future states may be provided to a decision support component (128 of FIG. 1), as shown in FIG. 7. The decision support component may provide a plurality of options for the future actions to be taken (e.g., buy a hard drive, switch off the machine, or do nothing because everything is going as expected). In short, the decision support component 128 is configured to suggest one or more “best” actions considering the evolution of the subject datacenter.

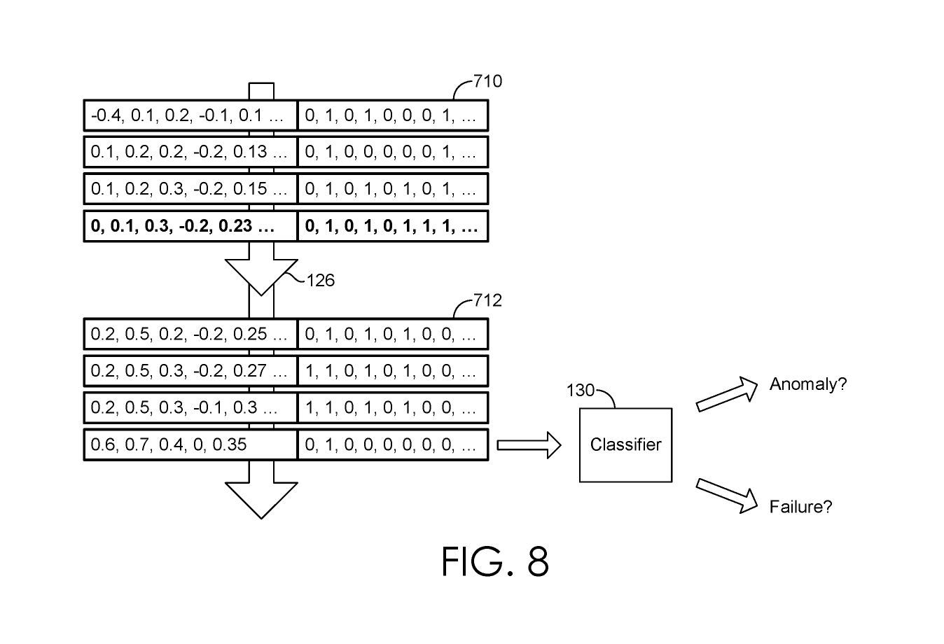

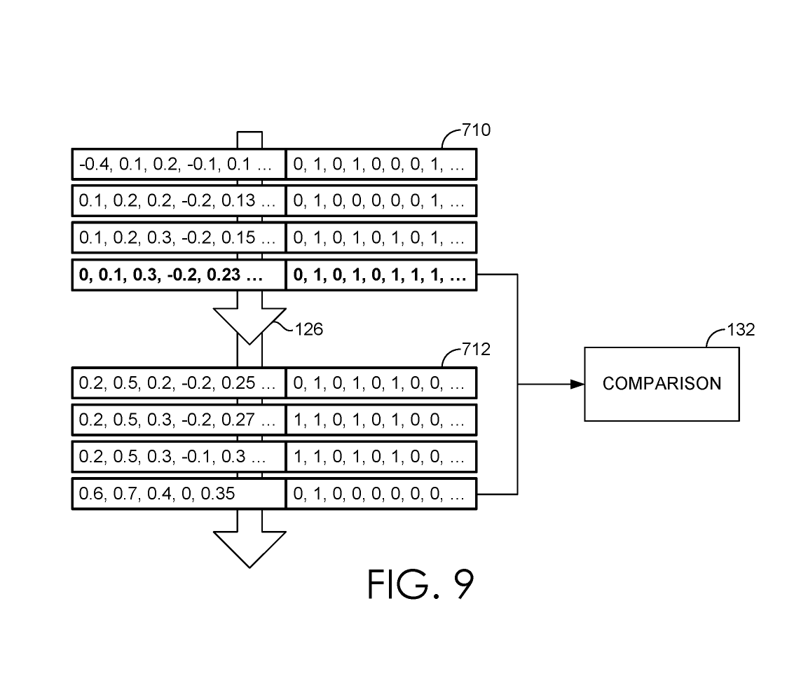

As illustrated in FIG. 8, instead of providing the predicted future states to a decision support system, the predicted future states may be provided to classifier component (130 of FIG. 1) to determine whether any of the predicted future states represents an anomaly or is likely to generate a failure. Additionally, instead of providing the predicted future states to a decision support system or a classifier component, the two sets of vector representations (input and predicted) may be compared with one another (e.g., utilizing comparison component 132 of FIG. 1) to see if anything has changed between them. This is illustrated in the schematic diagram of FIG. 9. It will be understood and appreciated by those having ordinary skill in the art that any number of decision support systems, classifier components and/or comparison components may be utilized in accordance with embodiments of the present disclosure, alone or in combination with one another.

Turning now to FIG. 10, a flow diagram is provided that illustrates a method 1000 that facilitates training a future state predictor to predict a future state of a node of an input datacenter, in accordance with embodiments of the present disclosure. For instance, the method 1000 may be employed utilizing the future state prediction system 100 of FIG. 1. As shown at step 1010, historical metrics are received from a plurality of historical nodes of a historical datacenter (e.g., utilizing the metric collection component 122 of FIG. 1). In embodiments, the plurality of historical nodes corresponds to a historical context graph indicating a plurality of relationships among the plurality of historical nodes. Each historical node corresponds to a component of the historical data center.

The historical metrics are aggregated (e.g., utilizing the state discovery component 124 of FIG. 1) into historical metric summary vector representations for the plurality of historical nodes in the historical datacenter at step 1012. The historical metric summary vector representations include information derived from the historical metrics of the neighbors of the plurality of historical nodes.

A future state predictor (e.g., future state predictor 126 of FIG. 1) is trained, at step 1014, with the historical metric summary vector representations (and/or enhanced metric summary vector representations, as herein above set forth). The future state predictor may be trained with an iterative training method. In embodiments, the future state predictor is utilized to predict a future state of a node of an input datacenter. In some embodiments, the future state prediction system is provided as a software as a service model. In this way, the future state predictor may be trained utilizing historical metric summary vector representations (and/or enhanced metric summary vector representations) received from a plurality of historical datacenters.

Referring now to FIG. 11, a flow diagram is provided that illustrates a method 1100 for utilizing a trained future state predictor to predict a future state of a node in a datacenter, in accordance with embodiments of the present disclosure. For instance, the method 1100 may be employed utilizing the future state prediction system 100 of FIG. 1. As shown at step 1110, metrics are received from a plurality of nodes in a datacenter (e.g., utilizing the metric collection component 122 of FIG. 1). The plurality of nodes corresponds to a context graph indicating a plurality of relationships among the plurality of nodes. Each node corresponds to a component of the datacenter.

At step 1112, the metrics are aggregated (e.g., utilizing the state discovery component 124 of FIG. 1) into a metric summary vector representation for a node of the plurality of nodes in the datacenter. The metric summary vector representation corresponds to a time-window prior to a future state and includes information derived from the metrics of neighbors of the node. In embodiments, one or more additional vector representations (e.g., node state pattern vector representations) may be concatenated with the metric summary vector representation to generate an enhanced vector representation. The trained future state predictor (e.g., future state predictor 126 of FIG. 1) is utilized, at step 1114, to predict a future state of the node.

Having described embodiments of the present disclosure, an exemplary operating environment in which embodiments of the present disclosure may be implemented is described below in order to provide a general context for various aspects of the present disclosure. Referring to FIG. 12 in particular, an exemplary operating environment for implementing embodiments of the present disclosure is shown and designated generally as computing device 1200. Computing device 1200 is but one example of a suitable computing environment and is not intended to suggest any limitation as to the scope of use or functionality of the inventive embodiments. Neither should the computing device 1200 be interpreted as having any dependency or requirement relating to any one or combination of components illustrated.

The inventive embodiments may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The inventive embodiments may be practiced in a variety of system configurations, including handheld devices, consumer electronics, general-purpose computers, more specialty computing devices, etc. The inventive embodiments may also be practiced in distributed computing environments where tasks are performed by remote-processing devices that are linked through a communications network.

With reference to FIG. 12, computing device 1200 includes a bus 1210 that directly or indirectly couples the following devices: memory 1212, one or more processors 1214, one or more presentation components 1216, one or more input/output (I/O) ports 1218, one or more input/output (I/O) components 1220, and an illustrative power supply 1222. Bus 1210 represents what may be one or more busses (such as an address bus, data bus, or combination thereof). Although the various blocks of FIG. 12 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 12 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 12 and reference to “computing device.”

Computing device 1200 typically includes a variety of computer-readable media. Computer-readable media can be any available media that can be accessed by computing device 1200 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1200. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1212 includes computer-storage media in the form of volatile and/or nonvolatile memory. The memory may be removable, non-removable, or a combination thereof. Exemplary hardware devices include solid-state memory, hard drives, optical-disc drives, etc. Computing device 1200 includes one or more processors that read data from various entities such as memory 1212 or I/O components 1220. Presentation component(s) 1216 present data indications to a user or other device. Exemplary presentation components include a display device, speaker, printing component, vibrating component, etc.

I/O ports 1218 allow computing device 1200 to be logically coupled to other devices including I/O components 1220, some of which may be built in. Illustrative components include a microphone, joystick, game pad, satellite dish, scanner, printer, wireless device, etc. The I/O components 1220 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1200. The computing device 1200 may be equipped with depth cameras, such as stereoscopic camera systems, infrared camera systems, RGB camera systems, and combinations of these, for gesture detection and recognition. Additionally, the computing device 1200 may be equipped with accelerometers or gyroscopes that enable detection of motion. The output of the accelerometers or gyroscopes may be provided to the display of the computing device 1200 to render immersive augmented reality or virtual reality.

As can be understood, embodiments of the present disclosure provide for predicting future states of a datacenter utilizing a trained future state predictor. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. A method comprising:
receiving historical metrics from a plurality of historical nodes of a historical datacenter, the plurality of historical nodes corresponding to a historical context graph indicating a plurality of relationships among the plurality of historical nodes, each historical node corresponding to a component of the historical datacenter;
aggregating the historical metrics into historical metric summary vector representations for the plurality of historical nodes in the historical datacenter, the historical metric summary vector representations including information derived from the historical metrics of neighbors of the plurality of historical nodes; and
training a future state predictor with the historical metric summary vector representations to predict a future state of a node of an input datacenter.

2. The method of claim 1, wherein the historical metrics comprise one or more of a temperature of one or more components of the historical datacenter, a work load of one or more components of the historical datacenter, network usage, input/output (IO) operations, a functionality of a node, or processor capacity.

3. The method of claim 1, further comprising:
concatenating a node state pattern vector to each historical metric summary vector to generate a plurality of enhanced historical vector representations; and
training the future state predictor with the enhanced historical vector representations to predict the future state of the node of the input datacenter.

4. The media of claim 1, further comprising receiving metrics corresponding to a plurality of nodes of the input datacenter.

5. The media of claim 4, further comprising aggregating the metrics into a metric summary vector representation for a node of the plurality of nodes of the input datacenter, the vector representation corresponding to a time-window prior to a future state and including information derived from the metrics of neighbors of the node.

6. The method of claim 5, utilizing the future state predictor, predicting the future state of the node.

7. The method of claim 1, wherein the historical metrics and the metrics are received from different datacenters.

8. The method of claim 1, wherein the future state predictor includes a first neural network that processes each vector representation of prior and current states.

9. The method of claim 8, further comprising, upon processing the vector representation of a current state, transferring a resulting pattern to a second neural network that generates a sequence of predicted states, the resulting pattern identifying vector representations having similar conditions to the current state and corresponding to subgraphs that, when aggregated, are similar to a portion of the context graph.

10. The method of claim 6, further comprising providing the future state of the node to a decision support system.

11. The method of claim 10, further comprising receiving a recommendation from the decision support system, the recommendation comprising taking a particular action or taking no action.

12. The method of claim 6, further comprising providing the future state of the node to a classifier that predicts an anomaly or failure of the node.

13. A method comprising:
receiving metrics from a plurality of nodes in a datacenter, the plurality of nodes corresponding to a context graph indicating a plurality of relationships among the plurality of nodes, each node corresponding to a component of the datacenter;
aggregating the metrics into a metric summary vector representation for a node of the plurality of nodes in the datacenter, the vector representation corresponding to a time-window prior to a future state and including information derived from the metrics of neighbors of the node; and
utilizing a future state predictor that has been trained to predict futures states of the node, predicting a future state of the node.

14. The method of claim 13, further comprising concatenating a node state pattern vector to the metric summary vector to generate an enhanced vector representation.

15. The method of claim 14, further comprising providing the future state of the node to a decision support system.

16. The system of claim 15, further comprising receiving a recommendation from the decision support system.

17. The system of claim 16, wherein the recommendation includes taking a particular action including purchasing a new component for the datacenter or powering off a component in the datacenter.

18. The system of claim 16, wherein the recommendation includes taking no action.

19. The method of claim 14, further comprising providing the future state of the node to a classifier that predicts an anomaly or failure.

20. A computerized system:
a processor; and
a non-transitory computer storage medium storing computer-useable instructions that, when used by the processor, cause the processor to:
receive historical metrics from a plurality of historical nodes in a historical datacenter corresponding to a historical context graph indicating a plurality of relationships among the plurality of historical nodes corresponding to components of the historical datacenter;
aggregate the historical metrics into historical metric summary vector representations for the plurality of historical nodes in the historical datacenter, the historical metric summary vector representations including information derived from the historical metrics of neighbors of the plurality of historical nodes;
train a future state predictor with the historical metric summary vector representations to predict a future state of a node for an input datacenter;
receive metrics from a plurality of nodes in the datacenter corresponding to a time-window prior to the future state;
aggregate the metrics into a metric summary vector representation for the node of the plurality of nodes in the datacenter, the metric summary vector representation corresponding to the time-window prior to the future state and including information derived from the metrics of neighbors of the node; and
utilizing the future state predictor, predict the future state of the node.
